(19) United States
(12) Patent Application Publication
(10) Pub. No.: US 2023/0005003 A1
(43) Pub. Date: Jan. 5, 2023

(54) Business Method Using Neutro System

(71) Applicant: Hak Yun Cho, Los Angeles, CA (US)

(72) Inventor: Hak Yun Cho, Los Angeles, CA (US)

(21) Appl. No.: 17/367,565

(22) Filed: Jul. 5, 2021

(51) Int. Cl. G06Q 30/02; G06Q 10/10

(52) U.S. Cl. CPC G06Q 30/0214; G06Q 30/0213; G06Q 30/0236; G06Q 10/1053

(57) ABSTRACT

According to a business method using neutro system of the present invention, participants can earn enough profits from sales made by themselves, commissions from the recruit of downline participants, and an additional bonus from the company. Participants also can earn double commissions by re-enrolling himself or herself as avatars under his or her own placement tree.

In addition, as participants are encouraged to sell products and recruit people based on the strong compensation plans, the company also can earn continuous and secure profits from participants' active sales activities, recruiting, and periodical re-enrolling as avatars.

### FIELD OF THE INVENTION

The present invention pertains generally to business methods, and more particularly to business methods for retail marketing.

### BACKGROUND OF THE INVENTION

There is a marketing strategy for the sales of products where the company earns profit from unsalaried salespeople selling the company's products while the profit of the unsalaried salespeople is derived from compensation commission.

Participants can earn profit from commissions of sales made by themselves and additional commissions based on the sales made by other participants recruited into their downline. A downline may include direct recruits, recruits' recruits, and so on.

Although many companies choosing this marketing strategy have developed a variety of compensation plans, there has been difficult to maintain a balance between companies and salespeople with regard to distribution of profits and to enlarge the network for continuous growth of the companies.

### SUMMARY OF THE INVENTION

The present invention provides business methods for using neutro system.

According to the business method using neutro system of the present invention, the business method using neutro system comprising: generating a placement tree including a plurality of position arranged hierarchically in a plurality of levels, in a main server, wherein a single position of the plurality of position in a higher level of the plurality of levels has one or two positions in a lower level, that is immediately below the higher level, of the plurality of levels; enrolling a person in a business of a company and placing the person as a frontline sponsor in a peak position in a first level in the placement tree, wherein the frontline sponsor is enrolled in the business by purchasing a product of the company and making an agreement with the company through a frontline sponsor terminal connectable to the main server; enrolling and placing one or two downline sponsors, who are recruited either by the company or the frontline sponsor, in a second level directly below the first level in the placement tree, wherein the downline sponsor is enrolled in the business by purchasing a product of the company and making the agreement with the company through a downline sponsor terminal connectable to the main server; enrolling and placing at least one downline sponsor in at least one level under the second level in the placement tree, wherein the downline sponsor under the second level is recruited either by the company or the downline sponsor who is in a position directly above; providing a recruiting commission to the sponsor based on the number of the sponsor who is below the sponsor whom the recruiting commission is provided to, and re-enrolling the frontline sponsor as an avatar sponsor and placing the avatar sponsor in a position in any level under the first level in the placement tree, wherein the frontline sponsor is re-enrolled by purchasing a product of company again in the main server through the frontline sponsor terminal, wherein the plurality of levels includes at least one of re-enrolling levels that the frontline sponsor re-enrolls himself or herself as the avatar sponsor.

When re-enrolling the frontline sponsor as an avatar sponsor, the re-enrolling levels includes: a fifth level and levels for multiples of five, and a seventh level and levels for seven plus multiples of five.

At least one position in a higher level has a single position in a lower level, that is immediately below the higher level, of the plurality of levels.

When re-enrolling the frontline sponsor as an avatar sponsor, the re-enrolling levels includes: a fifth level, a seventh level, and a ninth level to a twentieth level.

The business method using neutron system further comprises supporting either the front sponsor or the downline sponsor by placing a new downline sponsor, who is recruited by the company, in the placement tree.

The providing the recruiting commission includes: providing a first recruiting commission to the frontline sponsor based on the number of the downline sponsor, and providing a second recruiting commission to the downline sponsor based on the number of the downline sponsor who is below the downline sponsor whom the second recruiting commission is provided to.

When providing the first recruiting commission, the number of the downline sponsor includes one who is recruited by the company as well as one who is recruited by the frontline sponsor, and wherein when providing the second recruiting commission, the number of the downline sponsor, who is below the downline sponsor whom the second recruiting commission is provided to, includes one who is recruited by the company as well as one who is recruited by the downline sponsor whom the second recruiting commission is provided to.

The business method using neutron system further comprises providing a bonus to the frontline sponsor based on at least one of: the number of the downline sponsor, the levels placed by the downline sponsor, the number of customers who purchases a product of the company from the frontline sponsor, and the number of the downline sponsor who is recruited by the frontline sponsor.

The bonus includes a first bonus type that is provided only when a set of requirements below is satisfied: the downline sponsor is placed up to at least a first target level, and the number of the downline sponsor reaches to a first target sponsor number.

The first bonus type is provided to the frontline sponsor only when the requirements below are satisfied: the downline sponsor is placed up to at least the third level, and the number of the downline sponsor reaches to eight.

The first bonus type has a plurality of sets of requirements, and another set of requirements of the first bonus type is: the downline sponsor is placed up to at least a second target level, and the number of the downline sponsor reaches to a second target number.

The another set of requirements of the first bonus type is: the downline sponsor is placed up to at least a fourth level, and the number of the downline sponsor reaches to a sixteen number.

The bonus includes a second bonus type that is provided only when a set of requirements below is satisfied: the downline sponsor is placed up to at least a first target level; the number of the downline sponsor reaches to a first target sponsor number; the number of customers, who purchases a product of the company from the frontline sponsor, reaches to a first target customer number, and the number of the downline sponsor, who is recruited by the frontline sponsor, reaches to a first target recruiting number.

The second bonus type is provided to the frontline sponsor only when the requirements below are satisfied: the downline sponsor is placed up to at least a fifth level; the number of the downline sponsor reaches to thirty-two; the number of customers, who purchases a product of the company from the frontline sponsor, reaches to one thousand, and the number of the downline sponsor, who is recruited by the frontline sponsor, reaches to at least one.

The second bonus type has a plurality of sets of requirements, and another set of requirements of the second bonus type is: the downline sponsor is placed up to at least a second target level; the number of the downline sponsor reaches to a second target sponsor number; the number of customers, who purchases a product of the company from the frontline sponsor, reaches to a second target customer number, and the number of the downline sponsor, who is recruited by the frontline sponsor, reaches to a second target recruiting number.

The another set of requirements of the second bonus type is: the downline sponsor is placed up to at least a sixth level; the number of the downline sponsor reaches to sixty-four; the number of customers, who purchases a product of the company from the frontline sponsor, reaches to five thousand, and the number of the downline sponsor who is recruited by the frontline sponsor, reaches to at least one.

The business method using neutron system further comprises selling a product of the company through either the front sponsor or the downline sponsor.

According to the business method using neutro system of the present invention, the business method using neutron system comprising: generating a placement tree including a plurality of position arranged hierarchically in a plurality of levels, in a main server, wherein a single position of the plurality of position in a higher level of the plurality of levels has one or two positions in a lower level, that is immediately below the higher level, of the plurality of levels; enrolling a person in a business of a company and placing the person as a frontline sponsor in a peak position in a first level in the placement tree, wherein the frontline sponsor is enrolled in the business by purchasing a product of the company and making an agreement with the company through a frontline sponsor terminal connectable to the main server; enrolling and placing one or two downline sponsors, who are recruited either by the company or the frontline sponsor, in a second level directly below the first level in the placement tree, wherein the downline sponsor is enrolled in the business by purchasing a product of the company and making the agreement with the company through a downline sponsor terminal connectable to the main server; enrolling and placing at least one downline sponsor in at least one level under the second level in the placement tree, wherein the downline sponsor under the second level is recruited either by the company or the downline sponsor who is in a position directly above; providing a recruiting commission to the sponsor based on the number of the sponsor who is below the sponsor whom the recruiting commission is provided to, and re-enrolling the frontline sponsor as an avatar sponsor and placing the avatar sponsor in a position in any level under the first level in the placement tree, wherein the frontline sponsor is re-enrolled by purchasing a product of company again in the main server through the frontline sponsor terminal, wherein the plurality of levels includes at least one of re-enrolling levels that the frontline sponsor re-enrolls himself or herself as the avatar sponsor, wherein the re-enrolling levels includes: a fifth level, a seventh level, and a ninth level to twentieth level.

When providing the recruiting commission, the number of the sponsor, who is below the sponsor whom the recruiting commission is provided to, includes one who is recruited by the company as well as one who is recruited by the sponsor whom the recruiting commission is provided to, wherein providing the recruiting commission includes: providing a first recruiting commission to the frontline sponsor based on the number of the downline sponsor, and providing a second recruiting commission to the downline sponsor based on the number of the downline sponsor who is below the downline sponsor whom the second recruiting commission is provided to, wherein when providing the second recruiting commission, the number of the downline sponsor, who is below the avatar sponsor whom the second recruiting commission is provided to.

The business method using neutron system further comprises: providing a bonus to the frontline sponsor based on at least one of the number of the downline sponsor, the levels placed by the downline sponsor, the number of customers who purchases a product of the company from the frontline sponsor, and the number of the downline sponsor who is recruited by the frontline sponsor, and providing a bonus to the avatar sponsor based on at least one of the number of the downline sponsor, who is below the avatar sponsor whom the bonus is provided to, the levels placed by the downline sponsor, who is below the avatar sponsor whom the bonus is provided to, the number of customers who purchases a product of the company from the avatar sponsor, who the bonus is provided to, and the number of the downline sponsor, who is recruited by and is below the avatar sponsor whom the bonus is provided to.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1A is a flow chart showing a process of a business method M100 using neutro system 100 in views of a frontline sponsor 10, a company 20, and a downline sponsor 30 according to one embodiment of the present invention.

FIG. 1B is a flow chart showing a process of a business method M100 using neutro system 100.

FIG. 2 is a schematic drawing showing a placement tree of sales force according to one embodiment of the present invention.

FIG. 3 is a block diagram of the neutro system 100 used for the business method M100.

FIG. 4 is a block diagram of a control server 101 of the neutro system 100 in FIG. 3.

FIG. 5 is a table showing a bonus plan according to one embodiment of the present invention.

FIG. 6 is a schematic drawing showing a placement tree of sales force according to another embodiment of the present invention.

FIG. 7 is a schematic drawing showing a placement tree of sales force according to another embodiment of the present invention.

FIG. 8 is a schematic drawing showing a placement tree of sales force according to another embodiment of the present invention.

### DETAILED DESCRIPTION EMBODIMENTS OF THE INVENTIONS

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as form “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

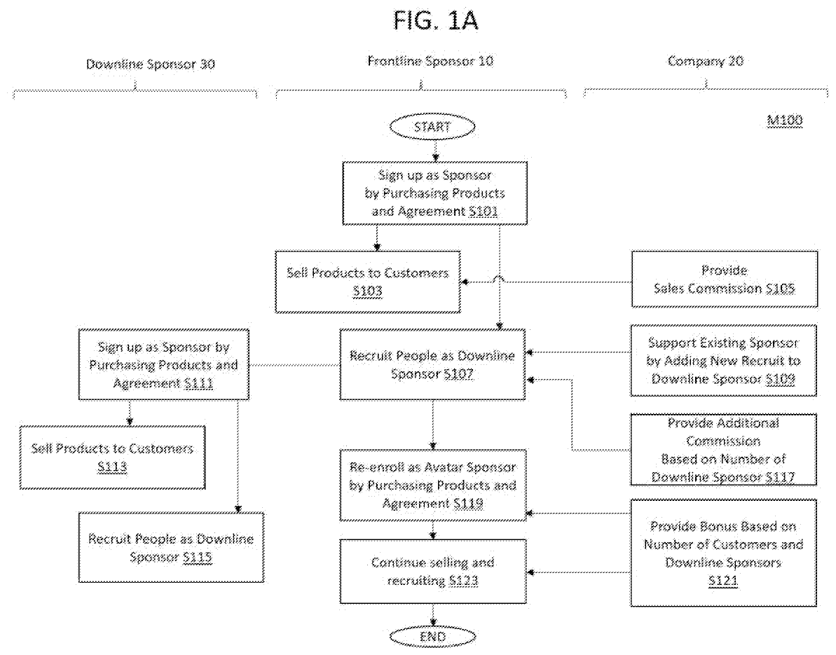

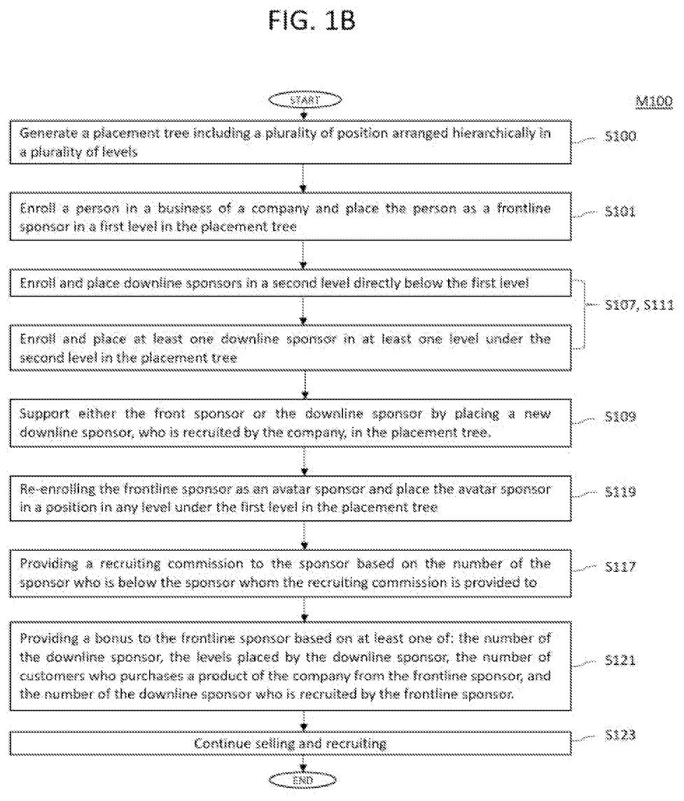

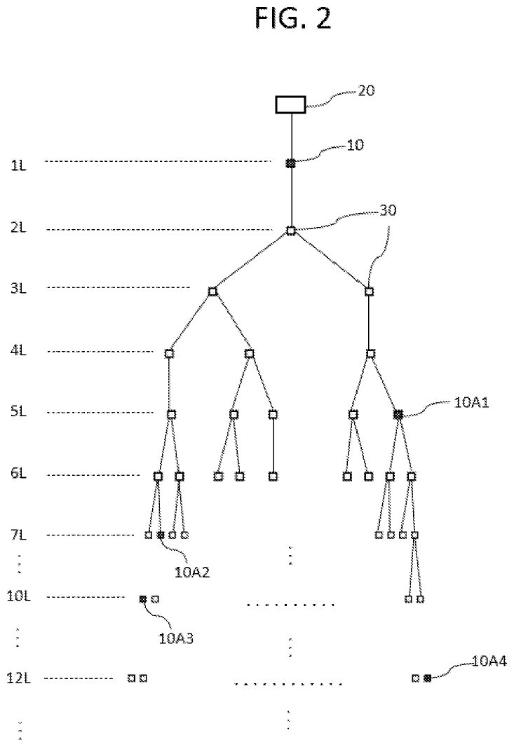

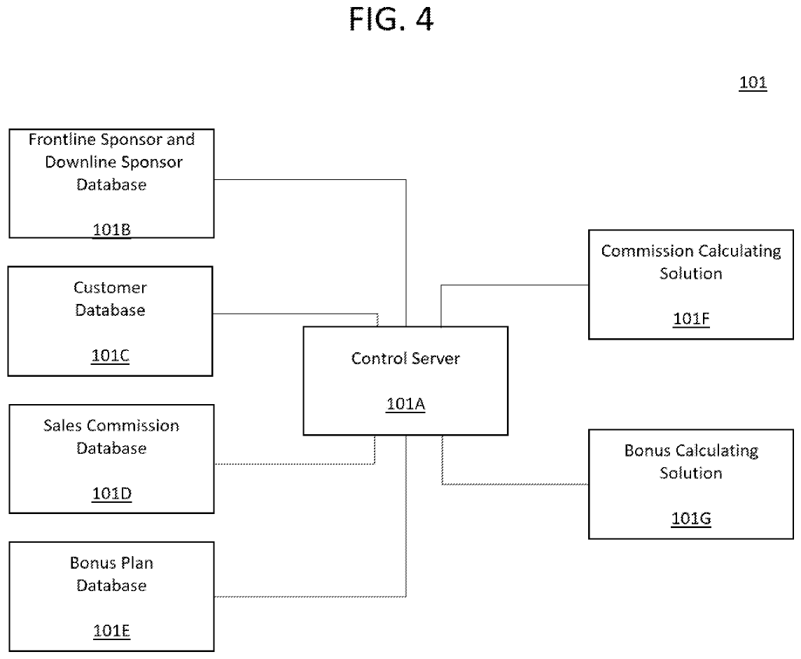

FIG. 1A is a flow chart showing a process of a business method M100 using neutro system 100 in views of a frontline sponsor 10, a company 20, and a downline sponsor 30 according to one embodiment of the present invention. FIG. 1B is a flow chart showing a process of a business method M100 using neutro system 100. FIG. 2 is a schematic drawing showing a placement tree of a sales force according to one embodiment of the present invention. The neutro system 100 is illustrated in FIG. 4.

According to FIGS. 1A to 2, the business method using neutro system M100 may start with generating a placement tree including a plurality of position arranged hierarchically in a plurality of levels, in a main server S100. In this instance, a single position of the plurality of position in a higher level of the plurality of levels has one or two positions in a lower level, that is immediately below the higher level, of the plurality of levels. As illustrated in FIG. 2, the frontline sponsor 10 may have a single downline sponsor 30 in a second level 2L. A first downline sponsor in a third level may have two downline sponsors in a fourth level, who is directly below the first downline sponsor, while a second downline sponsor in the third level may have single downline sponsors in the fourth level, who is directly below the second downline sponsor.

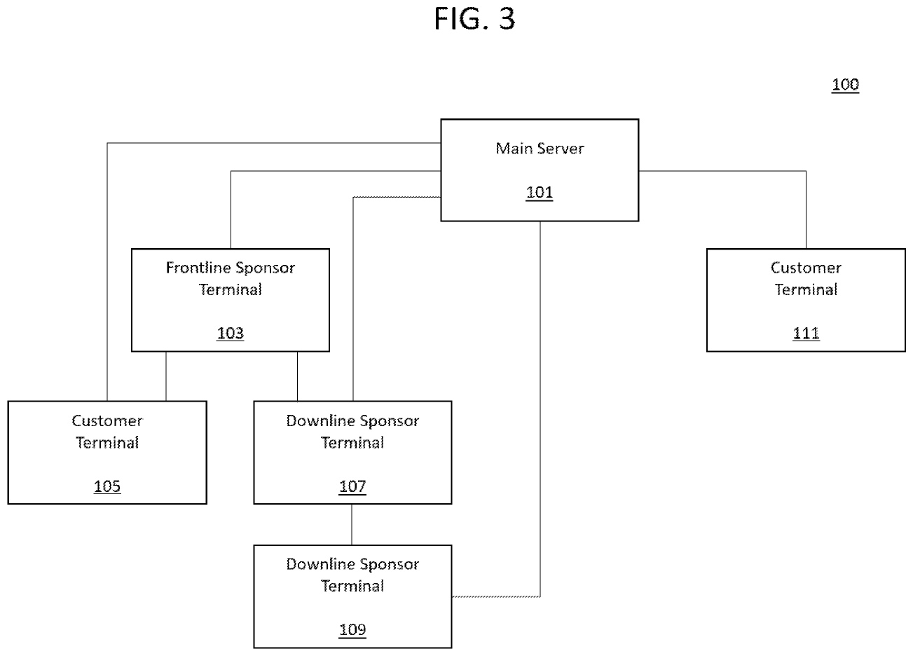

Then, the company 20 enrolls a person in a business of a company 20 and places the person as the frontline sponsor 10 in a peak position in a first level 1L in the placement tree. The frontline sponsor 10 is enrolled in and singing up to a business by purchasing products and making an agreement with a company 20 through a frontline sponsor terminal 103 (shown in FIG. 3) connectable to the main server 101 (shown in FIG. 3) S101. The frontline sponsor 10 is a representative who directly recruits another person into the business as well as sells products on behalf of the company 20. They may sell products to customers S103, and recruit people as their downline sponsor 30, S107. The company 20 provides sales commission S105 for their sales activities, and recruiting commissions to the sponsor based on the number of the sponsor who is below the sponsor whom the recruiting commission is provided to S117. Specifically, the company 20 provides a first recruiting commission to the frontline sponsor 10 based on the number of the downline sponsor 30, and also provides a second recruiting commission to the downline sponsor 30 based on the number of the downline sponsor who is below the downline sponsor 30 whom the second recruiting commission is provided to.

For example, the frontline sponsor 20 can earn $10 whenever they or their existing downline sponsor 30 recruit another downline sponsor 30. Likewise, the downline sponsor 30 can earn $10 whenever they or their existing downline sponsor 30 recruit another downline sponsor 30. Meanwhile, the company 20 may support the frontline sponsor 10 by adding new recruits to their downline sponsor 30, S109. The frontline sponsor 10 can obtain benefits from the company 20 based on the downline sponsor 30 who has been added by the company 20. In other words, when the company 20 provides recruiting commissions to the frontline sponsor, the number of the downline sponsor includes one who is recruited by the company 20 as well as one who is recruited by the frontline sponsor 10.

Likewise, when the company 20 provides the recruiting commission to the downline sponsor 30, the number of the downline sponsor 30, who is below the downline sponsor 30 whom the second recruiting commission is provided to, includes one who is recruited by the company 20 as well as one who is recruited by the downline sponsor 30 whom the recruiting commission is provided to. For example, when the downline sponsor 30, who has been added by the company 20, recruits another downline sponsor 30, the frontline sponsor 10 also gains additional commissions from this.

After enrolling the frontline sponsor, a new recruit becomes the downline sponsor 30 after signing up by purchasing products and making an agreement with the company 20, S111. Specifically, the company 20 enrolls and places one or two downline sponsors 30, who are recruited either by the company 20 or the frontline sponsor 10, in a second level 2L directly below the first level 1L in the placement tree. Referring to FIG. 2 together, the frontline sponsor 10 is positioned in the first level 1L, and one downline sponsor 30 is positioned in the second level 2L. This means that one downline sponsor 30 in the second level 2L is directly below the frontline sponsor 10.

In this instance, downline sponsor 30 may be recruited by either by the company 20 or the frontline sponsor 10. The downline sponsor 30 is enrolled in the business by purchasing a product of the company 20 and making the agreement with the company 20 through a downline sponsor terminal 103 connectable to the main server 101.

The present invention allows not only binary but also single or multiple recruiting system. In some embodiments, at least one position in a higher level has a single position in a lower level, that is immediately below the higher level, of the plurality of levels.

Likewise, the company 20 enrolls and places at least one downline sponsor 30 in at least one level, such as a third level 3L, a fourth level 3L, a fifth level 5L, and so on, under the second level 2L in the placement tree. The downline sponsor 30 under the second level 2L is recruited either by the company 20 or the downline sponsor 30 who is in a position directly above;

The downline sponsor 30 may sell products to customers S113, and recruit people as their downline sponsor S115.

Then, the company 20 re-enrolls the frontline sponsor 10 as an avatar sponsor 10A1, 10A2, 10A3, 10A4 and placing the avatar sponsor 10A1, 10A2, 10A3, 10A4 in a position in any level under the first level 1L in the placement tree S119. Specifically, as the number of downline sponsor 30 increases and reaches a certain level, the frontline sponsor 10 needs to re-enroll or sign up to the business as an avatar sponsor by purchasing products and making an agreement with the company 20, S119. The avatar sponsor indicates the frontline sponsor 10 who re-enrolls as a downline sponsor under his or her own line. The frontline sponsor 10 has a responsibility to be the avatar sponsor at some certain points.

In some embodiments, the plurality of levels in the placement tree includes a plurality of re-enrolling levels that the frontline sponsor 10 re-enrolls himself or herself as the avatar sponsor 10A1, 10A2, 10A3, 10A4. For example, the plurality of re-enrolling levels includes: a fifth level 5L and levels for multiples of five, such as a tenth level 10L, a fifteenth level, and a seventh level 7L and levels for seven plus multiples of five, such as a twelfth level 12L, a seventeenth level. While at least one downline sponsor 30 is filled in the second, the third, and the fourth level 2L, 3L, 4L, the frontline sponsor 10 is required to re-enroll as the avatar sponsor 10A1 in the fifth level 5L. The avatar sponsor system allows the frontline sponsor 10 to earn double additional commissions as well as the company 20 can make continuous and secure profits from periodical re-enrolling and purchase of the products by the frontline sponsor 10.

The frontline sponsor 10 may have a responsibility of becoming an avatar sponsor 10A2 in a seventh level 7L as well. In addition, the responsibility of becoming an avatar sponsor may be occurred every five levels from the fifth and the seventh level 5L, 7L. Thus, the responsibility of becoming an avatar sponsor 10A3, 10A4 may be occurred in tenth and the twelfth level 10L, 12L. The requirements or levels that the responsibility of becoming an avatar sponsor is occurred may be various and not limited to the levels mentioned above.

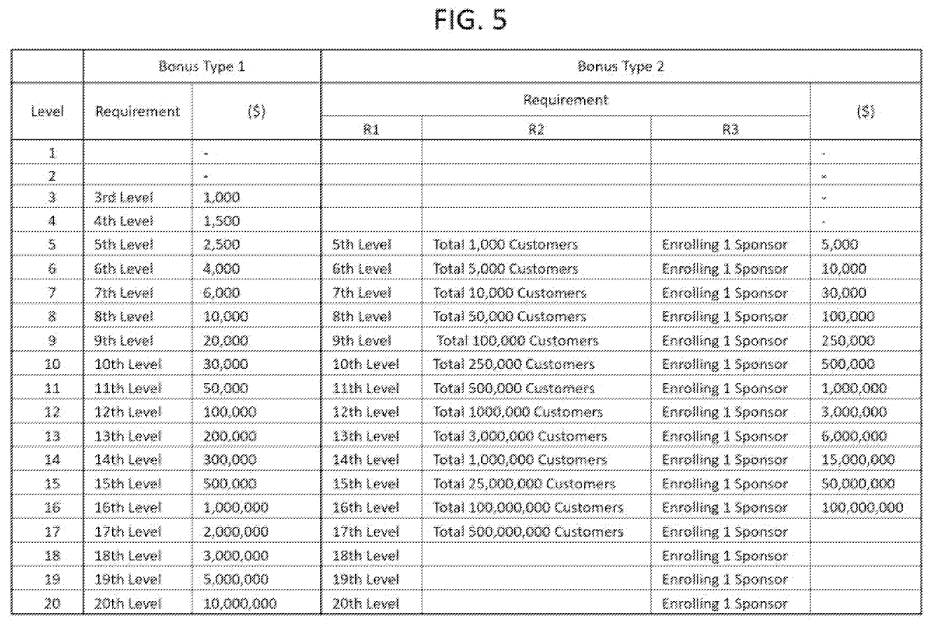

Meanwhile, as the frontline sponsor 10 continues selling and recruiting S123, the company 20 provides a bonus to the frontline sponsor 10 based on at least one of: the number of the downline sponsor 30, the levels placed by the downline sponsor 30, the number of customers who purchases a product of the company 20 from the frontline sponsor 10, and the number of the downline sponsor 30 who is recruited by the frontline sponsor 10, S121. The bonus will be explained in more details referring to FIG. 5. One embodiment of a detailed compensation plan may be under the following terms and conditions.

As mentioned above, the frontline sponsor 10 can earn $10 as a commission whenever they or their existing downline sponsor 30 recruit another downline sponsor 30. The commission based on recruiting the downline sponsor 30 may be provided to the frontline sponsor 10 up to downline sponsors 30 in a twentieth level.

The present invention allows not only binary but also single or multiple recruiting system. Thus, although the frontline sponsor 10 recruits one person into the business, the frontline sponsor 10 can earn continuous profits from the direct downline sponsor 30 and the other downline sponsor 30 who the direct downline sponsor 30 further recruits.

However, in order to avoid immoderate dependency on the support from the company 20, such as a supply of the downline sponsors, if the frontline sponsor 10 fails to recruit any one of the downline sponsor 30 by himself or herself within fourth level 4L, the frontline sponsor 10 may lose their right to gain commissions from the downline sponsors 30.

Meanwhile, if the frontline sponsor 10 recruits two downline sponsors 30 within fourth level 4L, the frontline sponsor 10 may earn commissions made by both of two downline sponsors 30. FIG. 3 is a block diagram of a neutro system 100 used for a business method M100 according to one embodiment of the present invention. FIG. 4 is a block diagram of a control server 101 of the neutro system 100 in FIG. 3.

According to FIGS. 1A to 4, the neutro system 100 used for a business method M100 may comprise a main server 101, a frontline sponsor terminal 103, a customer terminal 105, 111, a downline sponsor terminal 107. The neutro system 100 may further comprise a downline sponsor terminal 109, a terminal of a recruit's recruit.

The frontline sponsor 10 connects to the main server 101 operated by the company 20 to sign up the business using the frontline sponsor terminal 103. The main server 101 may be a form of website or a mobile application and can be accessed through internet.

The frontline sponsor terminal 103 communicates with customer and/or potential downline sponsor who have the customer terminal 105 and the downline sponsor terminal 107, 109 in order to promote the products or the business. Then, the customer can buy the products on the website or the mobile application provided by the main server 101. The potential downline sponsor also can sign up to the business on the website or the mobile application provided by the main server 101. Some customers may directly access to the website or the mobile application provided by the main server 101 with their customer terminals 111.

Referring to FIG. 4, the main server 101 may comprise a control server 101A, a frontline sponsor and downline sponsor data base 101B, a customer database 101C, a sales commission database 101D, a bonus plan data base, a commission calculating solution 101F, and a bonus calculating solution 101G.

FIG. 5 is a table showing a bonus plan according to one embodiment of the present invention.

According to FIG. 5, the bonus plan of the present invention includes two types. Each bonus plan has different requirements to cover various work aspects of participants.

According to bonus type 1, it requires that the downline sponsors 30 have been filled up to the certain level with certain numbers of downline sponsors. Thus, if the assigned spots in each levels have been filled with downline sponsors 30 properly, the frontline sponsor 10 can receive a bonus from the company 20.

Specifically, the bonus type 1 is provided only when a set of requirements below is satisfied: the downline sponsor 30 is placed up to at least a first target level, and the number of the downline sponsor 30 reaches to a first target sponsor number. For example, as described in FIG. 5, the first bonus type is provided to the frontline sponsor 10 only when the requirements below are satisfied: the downline sponsor is placed up to at least the third level, and the number of the downline sponsor reaches to eight.

In addition, the bonus type 1 has a plurality of sets of requirements, and another set of requirements of the bonus type 1 is: the downline sponsor 30 is placed up to at least a second target level, and the number of the downline sponsor reaches to a second target number. For example, as described in FIG. 5, the another set of requirements of the first bonus type is: the downline sponsor 30 is placed up to at least a fourth level, and the number of the downline sponsor 30 reaches to a sixteen number.

In one embodiment, if downline sponsors 30 are filled in all the assigned spots set by the company 20, for example, spots of a binary form, up to third level 3L, the frontline sponsor can earn $1,000 based on the bonus type 1. The downline sponsors 30 who are filled in the assigned spots may be recruited either by the frontline sponsor 10 or the company 20.

In some embodiments, the bonus plan may require that the frontline sponsor 10 can earn this bonus only if he or she recruits two downline sponsors 30 within the third level 3L. According to this plan, if the frontline sponsor 10 could not recruit two downline sponsors 30 until fourth level 4L, the frontline sponsor 10 cannot earn the bonus generated during the third level 3L.

In other embodiment, the bonus plan may require that the downline sponsors 30 who are filled in the assigned spots need to be recruited only by the frontline sponsor 10.

According to bonus type 2, the bonus type 2 is provided only when a set of requirements below is satisfied: the downline sponsor is placed up to at least a first target level; the number of the downline sponsor reaches to a first target sponsor number; the number of customers, who purchases a product of the company from the frontline sponsor, reaches to a first target customer number, and the number of the downline sponsor, who is recruited by the frontline sponsor, reaches to a first target recruiting number.

For example, as described in FIG. 5, the second bonus type is provided to the frontline sponsor only when the requirements below are satisfied: the downline sponsor is placed up to at least a fifth level; the number of the downline sponsor reaches to thirty-two; the number of customers, who purchases a product of the company from the frontline sponsor, reaches to one thousand, and the number of the downline sponsor, who is recruited by the frontline sponsor, reaches to at least one.

The second bonus type has a plurality of sets of requirements, and another set of requirements of the second bonus type is: the downline sponsor is placed up to at least a second target level; the number of the downline sponsor reaches to a second target sponsor number; the number of customers, who purchases a product of the company from the frontline sponsor, reaches to a second target customer number, and the number of the downline sponsor, who is recruited by the frontline sponsor, reaches to a second target recruiting number.

For example, as described in FIG. 5, the another set of requirements of the second bonus type is: the downline sponsor is placed up to at least a sixth level; the number of the downline sponsor reaches to sixty-four; the number of customers, who purchases a product of the company from the frontline sponsor, reaches to five thousand, and the number of the downline sponsor who is recruited by the frontline sponsor, reaches to at least one.

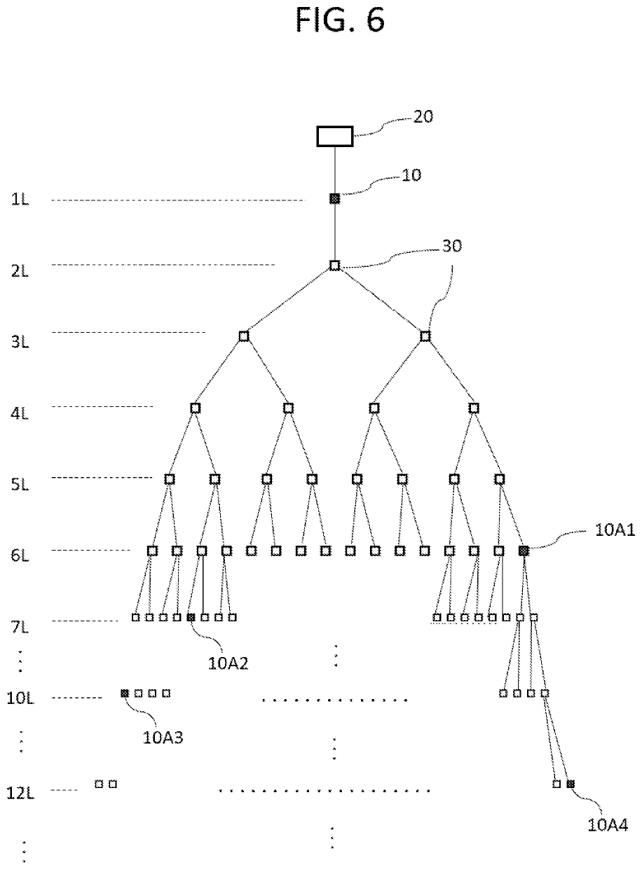

FIG. 6 is a schematic drawing showing a placement tree of a sales force according to another embodiment of the present invention.

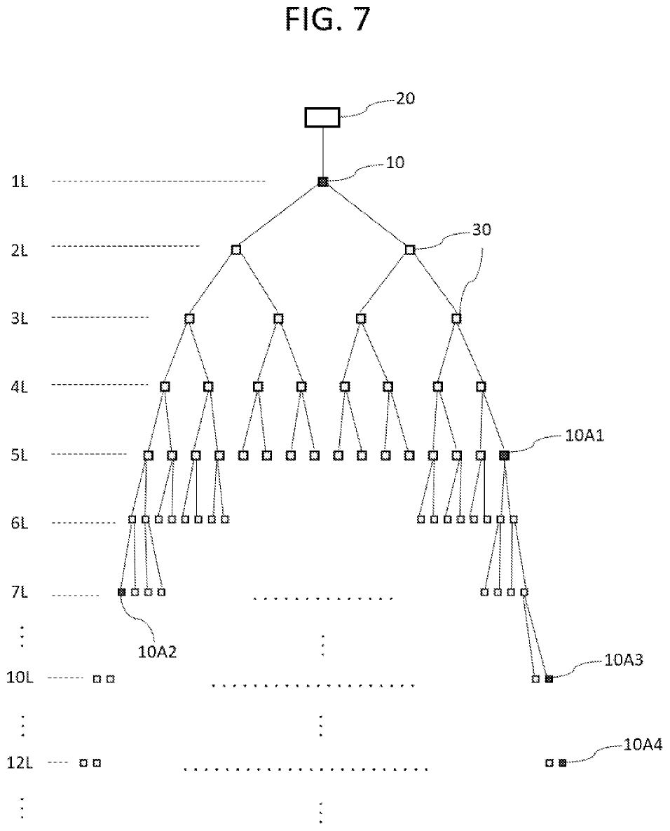

FIG. 7 is a schematic drawing showing a placement tree of a sales force according to another embodiment of the present invention.

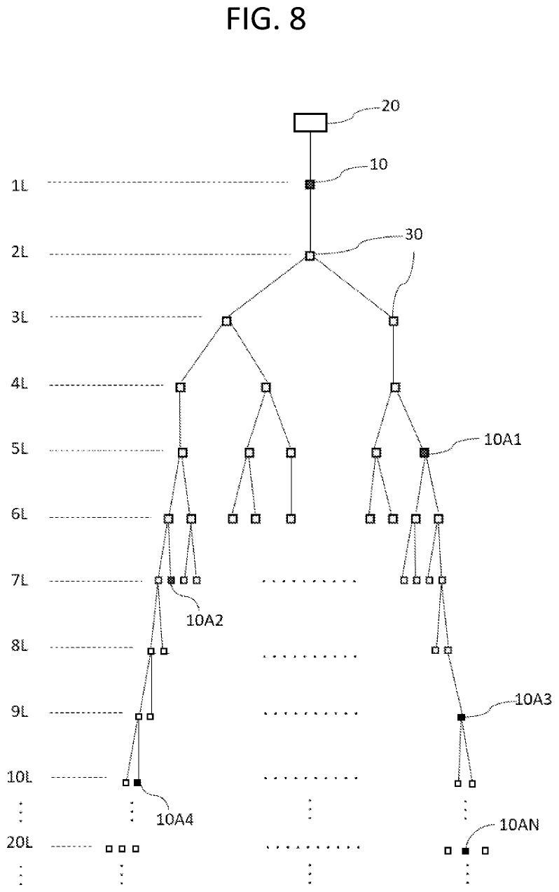

FIG. 8 is a schematic drawing showing a placement tree of sales force according to another embodiment of the present invention. The placement tree in FIG. 8 is similar to that in FIG. 2, but is different in views of the placements of the re-enrolling levels.

According to FIG. 8, when re-enrolling the frontline sponsor 10 as an avatar sponsor and placing the avatar sponsor 10A1, 10A2, 10A3, 10AN in the placement tree, the re-enrolling levels may be a fifth level 5L, a seventh level 7L, and a ninth level 9L to a twentieth level 20L. In each of the fifth level 5L, the seventh level 7L, and the ninth level 9L to the twentieth level 20L, the frontline sponsor 10 is required to re-enrolls himself or herself as the avatar sponsors 10A1, 10A2, 10A3, 10AN.

The avatar sponsors 10A1, 10A2, 10A3, 10AN in the fifth level 5L, the seventh level 7L, and the ninth level 9L to the twentieth level 20L can be provided the recruiting commission based on the number of the downline sponsor who is below the avatar sponsor whom the recruiting commission is provided to. In this instance, the number of the downline sponsor may include one who is recruited by the company as well as one who is recruited by the avatar sponsor whom the recruiting commission is provided to.

In some embodiments, at least one of the avatar sponsor may be selected to be provided the bonus mentioned above referring to FIGS. 1A to 5. For example, the avatar sponsor 10AN placed in the twentieth level 20L may be selected as an only level that the avatar sponsor 10AN therein is provided the bonus. In this case, the other avatar sponsors 10A1, 10A2, and 10A3 placed in the fifth level 5L, the seventh level 7L, and ninth level 9L to nineteen level 19L may not be provided any bonus.

As described above, the bonus can be determined and provided to the avatar sponsor 10AN based on at least one of: the number of the downline sponsor, who is below the avatar sponsor 10AN whom the bonus is provided to, the levels placed by the downline sponsor, who is below the avatar sponsor 10AN whom the bonus is provided to, the number of customers who purchases a product of the company from the avatar sponsor 10AN, who the bonus is provided to, and the number of the downline sponsor, who is recruited by and is below the avatar sponsor 10AN whom the bonus is provided to.

Even though the twentieth level 20L is selected as an only level that the avatar sponsor 10AN therein is provided the bonus in the embodiment above, the present invention is not limited to. In some embodiments, at least one of levels other than the twentieth level 20L may be selected as a level that the avatar sponsor therein is provided the bonus.

As described above referring to FIGS. 1A to 5, the bonus provided to the avatar sponsor 10AN is determined based on the bonus plan in FIG. 5. Accordingly, the avatar sponsor 10AN can receive a bonus based on the first bonus type and the second bonus type mentioned above.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A business method using neutron system comprising:
generating a placement tree including a plurality of position arranged hierarchically in a plurality of levels, in a main server, wherein a single position of the plurality of position in a higher level of the plurality of levels has one or two positions in a lower level, that is immediately below the higher level, of the plurality of levels;
enrolling a person in a business of a company and placing the person as a frontline sponsor in a peak position in a first level in the placement tree, wherein the frontline sponsor is enrolled in the business by purchasing a product of the company and making an agreement with the company through a frontline sponsor terminal connectable to the main server;
enrolling and placing one or two downline sponsors, who are recruited either by the company or the frontline sponsor, in a second level directly below the first level in the placement tree, wherein the downline sponsor is enrolled in the business by purchasing a product of the company and making the agreement with the company through a downline sponsor terminal connectable to the main server;
enrolling and placing at least one downline sponsor in at least one level under the second level in the placement tree, wherein the downline sponsor under the second level is recruited either by the company or the downline sponsor who is in a position directly above;
providing a recruiting commission to the sponsor based on the number of the sponsor who is below the sponsor whom the recruiting commission is provided to, and
re-enrolling the frontline sponsor as an avatar sponsor and placing the avatar sponsor in a position in any level under the first level in the placement tree, wherein the frontline sponsor is re-enrolled by purchasing a product of company again in the main server through the frontline sponsor terminal,
wherein the plurality of levels includes at least one of re-enrolling levels that the frontline sponsor re-enrolls himself or herself as the avatar sponsor.

2. The business method using neutron system according to claim 1, wherein when re-enrolling the frontline sponsor as an avatar sponsor, the re-enrolling levels includes:
a fifth level and levels of multiples of five, and
a seventh level and levels of seven plus multiples of five.

3. The business method using neutron system according to claim 1, wherein when re-enrolling the frontline sponsor as an avatar sponsor, the re-enrolling levels includes:
a fifth level,
a seventh level, and
a ninth level to a twentieth level.

4. The business method using neutron system according to claim 1, wherein at least one position in a higher level has a single position in a lower level, that is immediately below the higher level, of the plurality of levels.

5. The business method using neutron system according to claim 1, the business method using neutron system further comprises supporting either the front sponsor or the downline sponsor by placing a new downline sponsor, who is recruited by the company, in the placement tree.

6. The business method using neutron system according to claim 1, wherein providing the recruiting commission includes:
providing a first recruiting commission to the frontline sponsor based on the number of the downline sponsor, and
providing a second recruiting commission to the downline sponsor based on the number of the downline sponsor who is below the downline sponsor whom the second recruiting commission is provided to.

7. The business method using neutron system according to claim 1, wherein when providing the first recruiting commission, the number of the downline sponsor includes one who is recruited by the company as well as one who is recruited by the frontline sponsor, and
wherein when providing the second recruiting commission, the number of the downline sponsor, who is below the downline sponsor whom the second recruiting commission is provided to, includes one who is recruited by the company as well as one who is recruited by the downline sponsor whom the second recruiting commission is provided to.

8. The business method using neutron system according to claim 1, the business method using neutron system further comprises providing a bonus to the frontline sponsor based on at least one of:
the number of the downline sponsor,
the levels placed by the downline sponsor,
the number of customers who purchases a product of the company from the frontline sponsor, and
the number of the downline sponsor who is recruited by the frontline sponsor.

9. The business method using neutron system according to claim 8, wherein the bonus includes a first bonus type that is provided only when a set of requirements below is satisfied:
the downline sponsor is placed up to at least a first target level, and
the number of the downline sponsor reaches to a first target sponsor number.

10. The business method using neutron system according to claim 9, wherein the first bonus type is provided to the frontline sponsor only when the requirements below are satisfied:
the downline sponsor is placed up to at least the third level, and
the number of the downline sponsor reaches to eight.

11. The business method using neutron system according to claim 9, wherein the first bonus type has a plurality of sets of requirements, and another set of requirements of the first bonus type is:
the downline sponsor is placed up to at least a second target level, and
the number of the downline sponsor reaches to a second target number.

12. The business method using neutron system according to claim 11, wherein the another set of requirements of the first bonus type is:
the downline sponsor is placed up to at least a fourth level, and
the number of the downline sponsor reaches to a sixteen number.

13. The business method using neutron system according to claim 8, wherein the bonus includes a second bonus type that is provided only when a set of requirements below is satisfied:
the downline sponsor is placed up to at least a first target level;
the number of the downline sponsor reaches to a first target sponsor number;
the number of customers, who purchases a product of the company from the frontline sponsor, reaches to a first target customer number, and
the number of the downline sponsor, who is recruited by the frontline sponsor, reaches to a first target recruiting number.

14. The business method using neutron system according to claim 13, wherein the second bonus type is provided to the frontline sponsor only when the requirements below are satisfied:
the downline sponsor is placed up to at least a fifth level;
the number of the downline sponsor reaches to thirty-two;
the number of customers, who purchases a product of the company from the frontline sponsor, reaches to one thousand, and
the number of the downline sponsor, who is recruited by the frontline sponsor, reaches to at least one.

15. The business method using neutron system according to claim 13, wherein the second bonus type has a plurality of sets of requirements, and another set of requirements of the second bonus type is:
the downline sponsor is placed up to at least a second target level;
the number of the downline sponsor reaches to a second target sponsor number;
the number of customers, who purchases a product of the company from the frontline sponsor, reaches to a second target customer number, and
the number of the downline sponsor, who is recruited by the frontline sponsor, reaches to a second target recruiting number.

16. The business method using neutron system according to claim 15, wherein the another set of requirements of the second bonus type is:
the downline sponsor is placed up to at least a sixth level;
the number of the downline sponsor reaches to sixty-four;
the number of customers, who purchases a product of the company from the frontline sponsor, reaches to five thousand, and
the number of the downline sponsor who is recruited by the frontline sponsor, reaches to at least one.

17. The business method using neutron system according to claim 1, the business method using neutron system further comprises selling a product of the company through either the front sponsor or the downline sponsor.

18. A business method using neutron system comprising:
generating a placement tree including a plurality of position arranged hierarchically in a plurality of levels, in a main server, wherein a single position of the plurality of position in a higher level of the plurality of levels has one or two positions in a lower level, that is immediately below the higher level, of the plurality of levels;
enrolling a person in a business of a company and placing the person as a frontline sponsor in a peak position in a first level in the placement tree, wherein the frontline sponsor is enrolled in the business by purchasing a product of the company and making an agreement with the company through a frontline sponsor terminal connectable to the main server;
enrolling and placing one or two downline sponsors, who are recruited either by the company or the frontline sponsor, in a second level directly below the first level in the placement tree, wherein the downline sponsor is enrolled in the business by purchasing a product of the company and making the agreement with the company through a downline sponsor terminal connectable to the main server;
enrolling and placing at least one downline sponsor in at least one level under the second level in the placement tree, wherein the downline sponsor under the second level is recruited either by the company or the downline sponsor who is in a position directly above;
providing a recruiting commission to the sponsor based on the number of the sponsor who is below the sponsor whom the recruiting commission is provided to, and re-enrolling the frontline sponsor as an avatar sponsor and placing the avatar sponsor in a position in any level under the first level in the placement tree, wherein the frontline sponsor is re-enrolled by purchasing a product of company again in the main server through the frontline sponsor terminal,
wherein the plurality of levels includes at least one of re-enrolling levels that the frontline sponsor re-enrolls himself or herself as the avatar sponsor,
wherein the re-enrolling levels includes:
a fifth level,
a seventh level, and
a ninth level to twentieth level.

19. The business method using neutron system according to claim 18, wherein when providing the recruiting commission, the number of the sponsor, who is below the sponsor whom the recruiting commission is provided to, includes one who is recruited by the company as well as one who is recruited by the sponsor whom the recruiting commission is provided to,
wherein providing the recruiting commission includes:
providing a first recruiting commission to the frontline sponsor based on the number of the downline sponsor, and
providing a second recruiting commission to the downline sponsor based on the number of the downline sponsor who is below the downline sponsor whom the second recruiting commission is provided to,
wherein when providing the second recruiting commission, the number of the downline sponsor, who is below the avatar sponsor whom the second recruiting commission is provided to.

20. The business method using neutron system according to claim 18, the business method using neutron system further comprises:
providing a bonus to the frontline sponsor based on at least one of:
the number of the downline sponsor,
the levels placed by the downline sponsor,
the number of customers who purchases a product of the company from the frontline sponsor, and
the number of the downline sponsor who is recruited by the frontline sponsor, and
providing a bonus to the avatar sponsor based on at least one of:
the number of the downline sponsor, who is below the avatar sponsor whom the bonus is provided to,
the levels placed by the downline sponsor, who is below the avatar sponsor whom the bonus is provided to,
the number of customers who purchases a product of the company from the avatar sponsor, who the bonus is provided to, and
the number of the downline sponsor, who is recruited by and is below the avatar sponsor whom the bonus is provided to.
